(19) United States
(12) Patent Application Publication
(10) Pub. No.: US 2008/0314945 A1
(43) Pub. Date: Dec. 25, 2008

(54) COLLAPSIBLE CARGO CARRIER FOR MOTORIZED OR NON-MOTORIZED TRANSPORTATION DEVICES

(76) Inventor: Verlin V. Gibson, Defiance, MO (US)

Correspondence Address: POLSTER, LIEDER, WOODRUFF & LUCCHESI, 12412 POWERSCOURT DRIVE SUITE 200, ST. LOUIS, MO, 63131-3615, US

(21) Appl. No.: 11/767,288

(22) Filed: Jun. 22, 2007

(51) Int. Cl. B60R 9/06

(52) U.S. Cl. 224/403

(57) ABSTRACT

A collapsible cargo carrier (A) is installed on the bed (B) of a pickup truck. A pair of posts (3, 13) each have one end hingedly connected to one end of respective base rails (1, 11) for raising and lowering the posts. A pair of second posts (4, 14) each have one end slidably received in a slot (C) formed in the respective first posts. The slots extend substantially the length of the first posts for the second posts to be moved relative thereto. A pair of top rails (8, 18) each have one end connected to the other end of the respective first posts. The other end of each second post is slidably received in a slot in the respective top rails. Movable load clamps (9, 30) extend between the top rails to accommodate cargo of different sizes and clamp the cargo in place on the top of the carrier. The carrier construction allows different sizes and shapes of cargo to be conveniently and safely transported from one place to another. By having the capability to support this cargo while elevated above the truck bed, room for the storage and transport of other articles is readily available. The cargo is easily assembled and installed on the floor of a truck bed and removed after the cargo is delivered to its destination risers, or left in place for subsequent usage.

### CROSS REFERENCE TO RELATED APPLICATIONS

U.S. Pat. No. 7,051,909, U.S. patent application Ser. No. 11/072,157 filed Mar. 4, 2006

### BACKGROUND OF THE INVENTION

This invention relates to the transportation of articles loaded into the bed of a pickup truck or the like, and more particularly, to a collapsible cargo carrier removably installed in the truck bed for conveniently and safely transporting the article while enabling other cargo to be stored and carried in the truck bed.

It is often desirable to carry large and/or unwieldly articles in the bed of a pickup truck or the like. One problem with doing so is that while the article can be accommodated in truck bed, the size and shape of the article makes it difficult to store other articles in it. The cargo carrier disclosed herein provides a solution to this problem.

With regard to cargo carriers, it should first be noted that, most often, the cargo carried in the truck does not present a problem and therefore a cargo carrier may not be needed. However, if a carrier is permanently installed in the truck or truck bed, it may either take up space that could otherwise be used for storage, or make it difficult to place articles into, or remove them from, the truck bed.

Second, even if it is convenient to have the carrier installed in the truck, the carrier should take up a minimum amount of space when in use so that a carrier which is collapsible and requires little room in its collapsed position is desirable. Others have attempted a solution to this problem. See, for example, U.S. Pat. No. 6,332,637, and U.S. patent publication 2006/0045692.

### BRIEF SUMMARY OF THE INVENTION

The present invention is directed to a collapsible cargo carrier which can be removably installed in the bed of a pickup truck. A pair of first posts each have one end hingedly connected to one end of respective base rails that rest on the floor of the bed for raising and lowering the posts. A pair of second posts each have one end slidably received in slots formed in the respective first posts. These slots extend substantially the length of the first posts for the second post to be moved relative thereto. A pair of top rails each have one end connected to the other end of the respective first posts. The other end of each second post is slidably received in a slot in the respective top rails. Movable load clamp bars extend between the top rails to accommodate cargo of different sizes and clamp the cargo in place on the top of the carrier.

The carrier construction allows different sizes and shapes of cargo to be conveniently and safely transported from one place to another. By having the capability to support this cargo while elevated above the truck bed, room for the storage and transport of other articles is readily available. The cargo carrier is easily assembled and installed on the floor of a truck bed and removed after the cargo is delivered to its destination risers, or left in place for subsequent usage.

Other objects and features will be in part apparent and in part pointed out hereinafter.

### BRIEF DESCRIPTION OF THE SEVERAL VIEWS OF THE DRAWINGS

The objects of the invention are achieved as set forth in the illustrative embodiments shown in the drawings which form a part of the specification.

FIG. 1 is a side view of the cargo carrier of the present invention as installed in the bed of a pickup truck, the carrier being in a lowered position;

FIG. 2 is a top plan view of the carrier;

FIGS. 3 and 4 are respective front and rear elevation views of the carrier;

FIGS. 5 and 6 are side views of the carrier with the top rail raised to different levels;

FIGS. 7-9 are side views of the carrier with the top rail moved past horizontal as when an article on the carrier is being off-loaded;

FIGS. 10-12 are respective front, side, and top views of a second embodiment of a cargo carrier of the present invention; and,

FIG. 13 is a side view of a clamp used with the carrier;

FIGS. 14A and 14B are respective front and rear views of the clamp;

FIGS. 15A and 15B are respective top and bottom views of the clamp; and,

FIGS. 16A and 16B are respective left and right side views illustrating the clamp installed in place.

Corresponding reference characters indicate corresponding parts throughout the several views of the drawings.

### DETAILED DESCRIPTION OF INVENTION

The following detailed description illustrates the disclosure by way of example and not by way of limitation. This description will clearly enable one skilled in the art to make and use the invention, and describes several embodiments, adaptations, variations, alternatives and uses of the invention, including what I presently believe is the best mode of carrying out the invention. As various changes could be made in the above constructions without departing from the scope of the invention, it is intended that all matter contained in the above description or shown in the accompanying drawings shall be interpreted as illustrative and not in a limiting sense.

The following is a listing of the parts of comprising a cargo carrier A of the invention and includes the reference numerals for relating these components to the drawing figures:

| | |
|---|---|
| 1 | Base Rail - Right Side |
| 2 | Cam Lever - Right Side Front |
| 3 | Post - Right Side Front |
| 4 | Post - Right Side |
| 5 | Foot - Right Side Front |
| 6 | Cam Lever - Right Side Front |
| 7 | Bumper - Right Side Front |
| 8 | Top Rail - Right Side |
| 9 | Load Clamp - Top Rear |
| 10 | Cam Lever - Right Side Front |
| 11 | Base Rail - Left Side |
| 12 | Cam Lever - Left Side Front |
| 13 | Post - Left Side Front |
| 14 | Post - Left Side |
| 15 | Foot - Left Side Front |
| 16 | Cam Lever - Left Side Front |
| 17 | Bumper - Left Side Front |
| 18 | Top Rail - Left Side |
| 19 | Cam Lever - Left Side Front |
| 20 | Cam Lever - Right Side Front |
| 21 | Cam Lever - Left Side Front |
| 22 | Release - Center Front |
| 23 | Brace - Low Center Front |
| 24 | Brace - Lower Center Front |
| 25 | Brace - Middle Center Front |
| 26 | Brace - High Center Front |
| 27 | Brace - High Center Rear |
| 28 | Cam Lever - Right Side Front |
| 29 | Bumper - Left Side Front |
| 30 | Load Clamp - Top Rear |
| 31 | Cam Lever - Right Side Rear |
| 32 | Cam Lever - Left Side Rear |
| 33 | Bumper - Left Side Front |
| 34 | Cam Lever - Left Side Rear |
| 35 | Cam Lever - Right Side Rear |
| 36 | Brace - Center Front |
| 37 | Brace - Center Rear |
| 38 | Knob - Right Side Front |
| 39 | Knob - Left Side Front |
| 40 | Spacer - Right Side Front |
| 41 | Spacer - Left Side Front |
| 42 | Spacer - Right Side Middle |
| 43 | Spacer - Left Side Middle |
| 44 | Spacer - Right Side Front |
| 45 | Spacer - Right Side Front |
| 46 | Spacer - Left Side Front |
| 47 | Spacer - Left Side Front |
| 48 | Cam Lever - Left Side Rear |
| 49 | Cam Lever - Right Side Middle |
| 50 | Hinge - Right Side Front |
| 51 | Hinge - Left Side Front |
| 52 | Cam Lever - Left Side Middle |
| 53 | Knob - Right Side Rear |
| 54 | Knob - Left Side Rear |

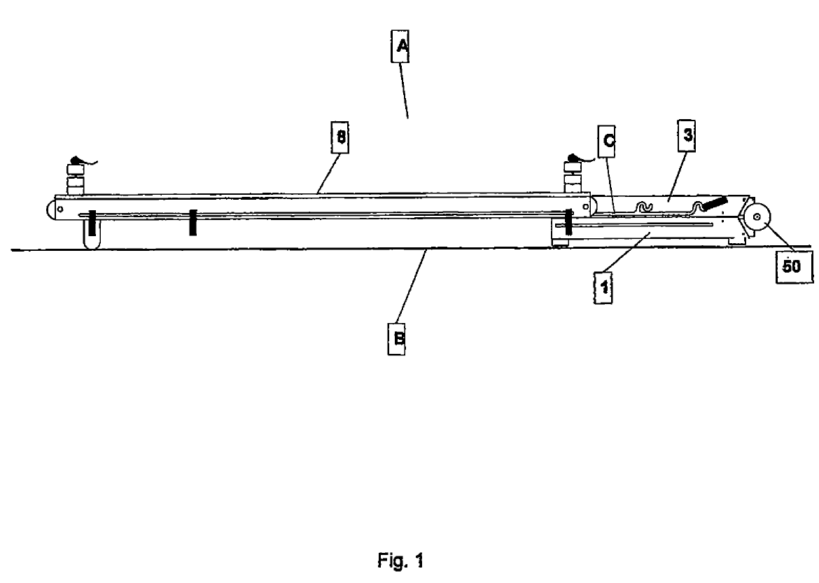

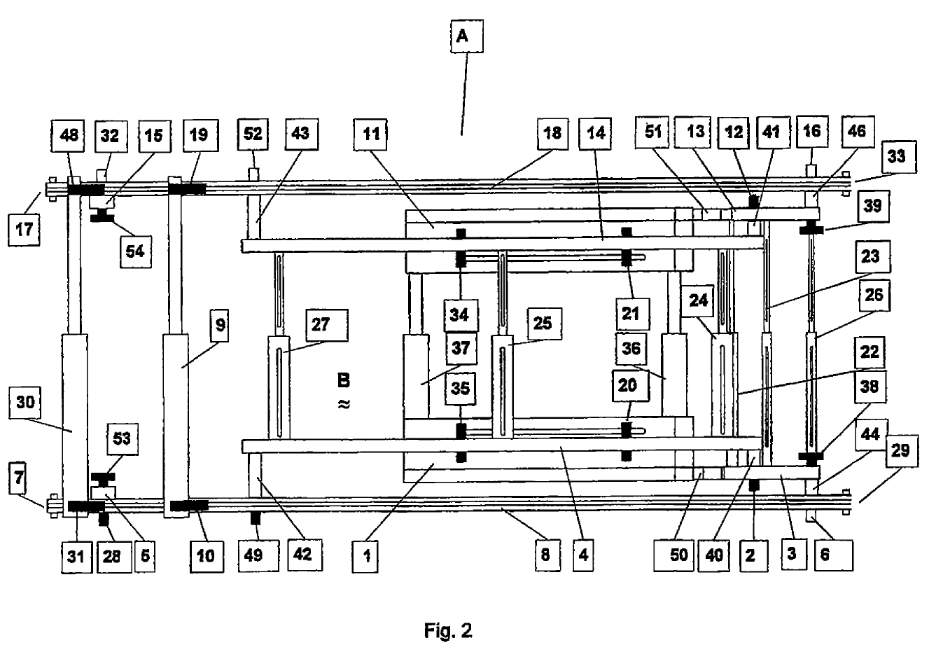

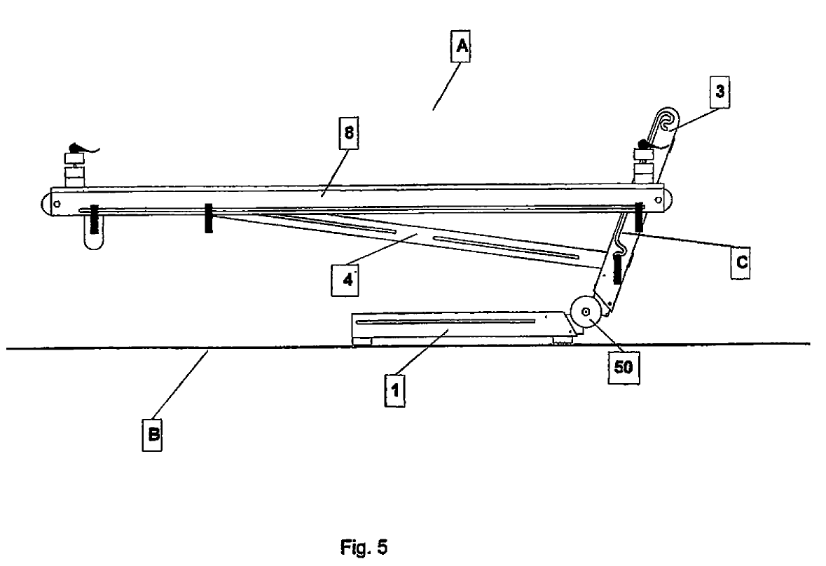

Cargo carrier A, as shown in FIG. 1 is installed in the bed B of a pickup truck (not shown). Base rails 1 and 11 of the carrier A rest upon the floor of the truck bed. As shown in the drawings, side posts 4 and 14 each have one end rotatably attached to a respective base rail by a hinge 50, 51. Top rails 8, 18 are slidably connected to the side posts so to elevate the top rails above the floor of the truck bed by rotating the side posts about their hinges as shown in FIGS. 5-7. An object to be transported by carrier A can be attached to the carrier while it is in its retracted position shown in FIG. 1, or in an elevated position. However, an advantage of the carrier is that once raised, the space beneath the top rails of the carrier and the truck bed is available for storage of other materials. When the carrier is not in use, it can be lowered to its position shown in FIG. 1, or taken apart and stored.

Assembly of carrier A in bed B of the truck is as follows:

First, right side base rail 1 and left side base rail 11 are joined together using center front brace 36 and center rear brace 37. The respective base rails are adjustable in length. Next, right side front hinge 50 is joined to right side base rail 1 and right side front post 3; and, left side front hinge 51 is joined to left side base rail 11 and left side front post 13. Center front release 22 connects between center front hinge 50 and center front hinge 51.

Right side front post 3 and left side front post 13 are joined together using low and high center front braces 23 and 26 respectively. Next, posts 3 and 4 are joined together with right side front cam lever 2, and right side front spacers 40 and 45. Left side front post 13 is joined to left side post 14 using left side front cam lever 12, and left side front spacers 41 and 47. Post 3 is joined to right side top rail 8 together with right side front cam lever 6, right side front spacer 44, right side front knob 38. Similarly, post 13 is joined to left side top rail 18 with left side front cam lever 16, left side front spacer 46, and left side front knob 39.

Right and left side posts 4 and 14 are joined together by lower center front, middle center front, and high center rear braces 24, 25 and 27 respectively. Post 4 is joined to top rail 8 with right side middle cam lever 49 and right side middle spacer 42. Post 14 is joined to top rail 18 with left side middle cam lever 52 and left side middle spacer 43. Right side front foot 5 is joined to top rail 8 with right side front cam lever 28 and right side rear knob 53. Left side rear foot 15 is joined to top rail 18 with left side rear cam lever 32 and left side rear knob 54.

Both right side front bumper 29 and right side rear bumper 7 join to top rail 8 at the front and rear ends, respectively, of the rail. Similarly, left side front bumper 33 and left side rear bumper 17 are joined to top rail 18. Front top load clamp 9 joins to both top rails 8 and 18 together with respective right and left side rear cam levers 10 and 19. In like manner, rear top load clamp 30 joins to both top rails 8 and 18 with right side rear cam lever 31 and left side rear cam lever 48. Right side front and rear cam levers 20 and 35 respectively join to base rail 1; while left side front and rear cam levers 21 and 34 respectively join to base rail 11.

Referring to FIGS. 1, 5 and 6, once installed on the floor B of a truck bed, the carrier is raised from the floor of the bed by grasping one or both of the top rails 8, 18 and lifting them.

This causes posts 3, 13 to pivot about their respect hinges 50, 51 and rotate upwardly in the clockwise direction shown in the drawings. It will be noted that top rails 8, 18 are connected to the base of carrier A only by the respective posts 3 and 13. These posts each have a longitudinally extending slot by which the respective top rails are slidingly moved; i.e., raised and lowered with respect to the base rails 1, 11 of carrier A. Similarly, the posts 4 and 14, which are in effect, cross-members, are slidingly movable together with the posts 3, 13 to elevate and lower the top rails.

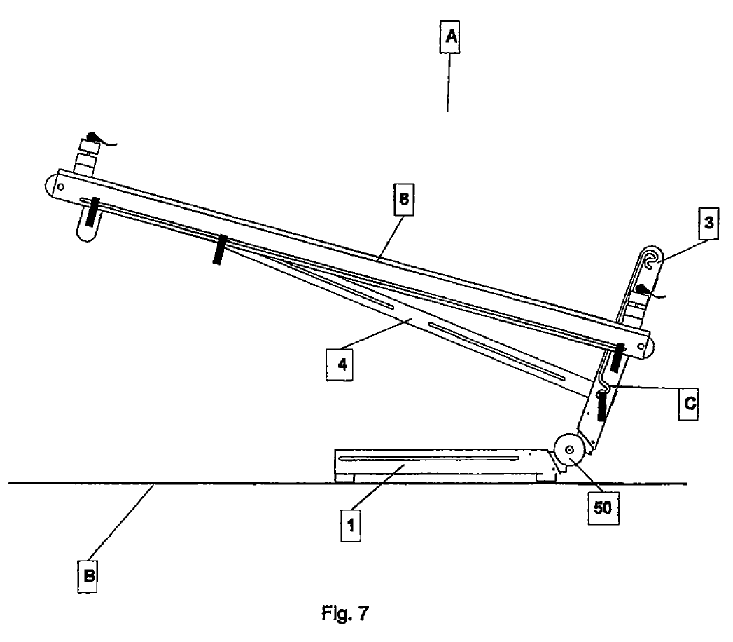

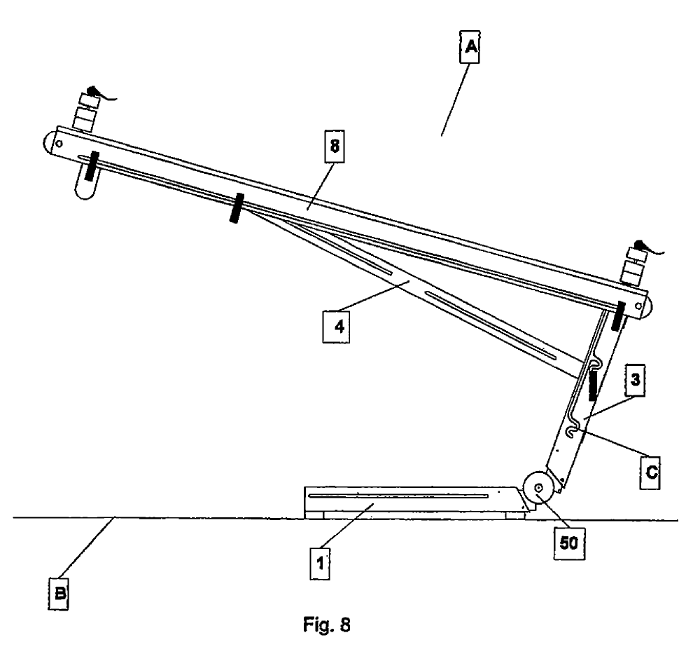

Once the top rails have raised to a desired, generally horizontal, position, the posts 1, 3, and 11, 13 are locked in place using the respective cam levers 2, 12, 49, and 52, and knobs 38, 39, 53, and 54. The cargo to be transported by carrier A is then loaded onto the carrier and locked in place using the load clamps 9 and 30. Once the cargo has reached its destination, and as shown in FIGS. 7-9, top rails can be further rotated clockwise so that the load will slide off the carrier and not have to be lifted off.

It will be understood by those skilled in the art that when not in use, carrier A is readily disassembled with the pieces stored in a convenient manner for future use.

In addition to the above described assembly of carrier A, there are optional ways of installing the carrier. Under one option:
1. Mount right side base rail 1 to the truck bed by drilling two holes in the vehicle where slots in the base rail intersect with the surface of the truck bed.
2. Install bolts in the base rail into the respective holes.
3. Install and tighten nuts onto the each of the bolts.
4. Repeat the above steps for left side base rail 11.

Under a second option:
1. Install two T-bolts into the in base rail 1.
2. Install a cam lever onto each of the respective T-bolts.
3. Slide the heads of each T-bolts into a T-slots such as is formed on a base such as shown and described in co-owned U.S. Pat. No. 7,051,909 which is incorporated herein by reference.
4. Tighten each of the cam levers installed above.
5. Repeat the above steps for left side base rail 11.

Under a third option:
1. Install two bolts through the slot in base rail 1.
2. Mount a saddle riser, as shown and described in my U.S. Pat. No. 7,051,909, onto the base rail using the bolts, install a nut onto each bolt, and tighten.
3. Install a rack clamp, as shown and described in my pending U.S. patent application Ser. No. 11/072,157 filed Mar. 4, 2006, onto an upper part of saddle riser.
4. Install the rack clamp onto a front wall of truck bed B and tighten.
5. Repeat the above steps for left side base rail 11.

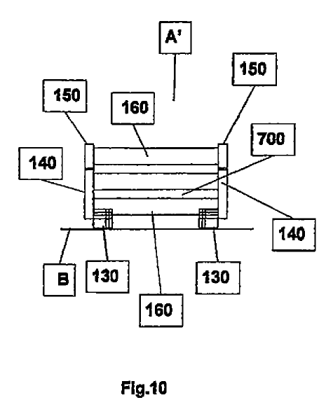

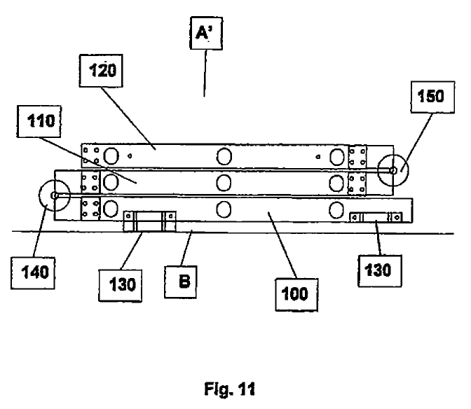

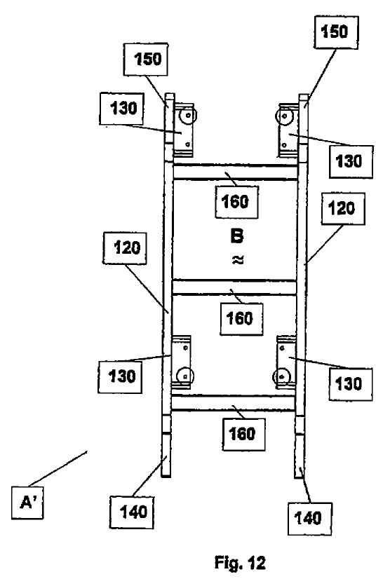

Referring now to FIGS. 10-12, a second embodiment A′ of the cargo carrier includes base attachment rails or arms 100 only one of which is shown in FIG. 11. The other base attachment arm (not shown) extends parallel to arm 100 along the opposite side of the carrier. One end of each of a pair of post arms 110 (again only one of which is shown in the drawings) is rotatably connected to one end of each base attachment arm by a hinge 140. The other end of each post arm 110 is rotatably connected to one end of a top rail support arm 120 (see FIG. 12) by a hinge 150 (See Attachment A). As shown in FIGS. 10 and 12, carrier A′ is attached to truck bed B by four base attachment units 130. One pair of attachment units are connected to one of the base attachments arms 100, at each end of the arm; and the other pair of attachment units 130 are connected to the other base attachment arm, at each end of this attachment arm. For convenience, the base attachment units are connected on the inside of the respective base attachment arms. Finally, cross braces 160 extend between the base attachment arms to add stability to carrier A′. Three braces 160 are used, one at each end of the carrier assembly, and one at the middle of it.

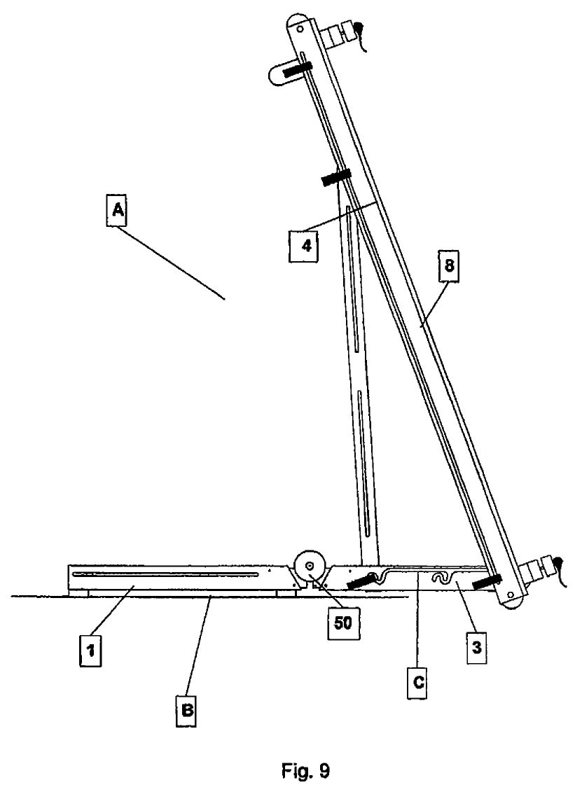

Operation of carrier A′ is similar to that of carrier A. That is, an object to be transported by the carrier is mounted on the carrier while it is still in its retracted position shown in FIG. 11, or in an elevated position. Once the cargo reaches its destination, the carrier is rotated over center so the top rail support arms 120 are in a position similar to that of the top rails 8, 18 shown in FIG. 9. In this position, the load readily slides off carrier A′ and does not have to be lifted off. Again, when carrier A′ is not in use, it can be lowered to its position shown in FIG. 11, or taken apart and stored. The advantages of carrier A′ over carrier A are first, that the posts 4 and 14 used in carrier A are not required; and second, the post arms 110 are now hingedly connected to the top rail support arms 120, whereas in carrier A, the posts 3 and 13 have a slotted connection to the top rails 8, 18.

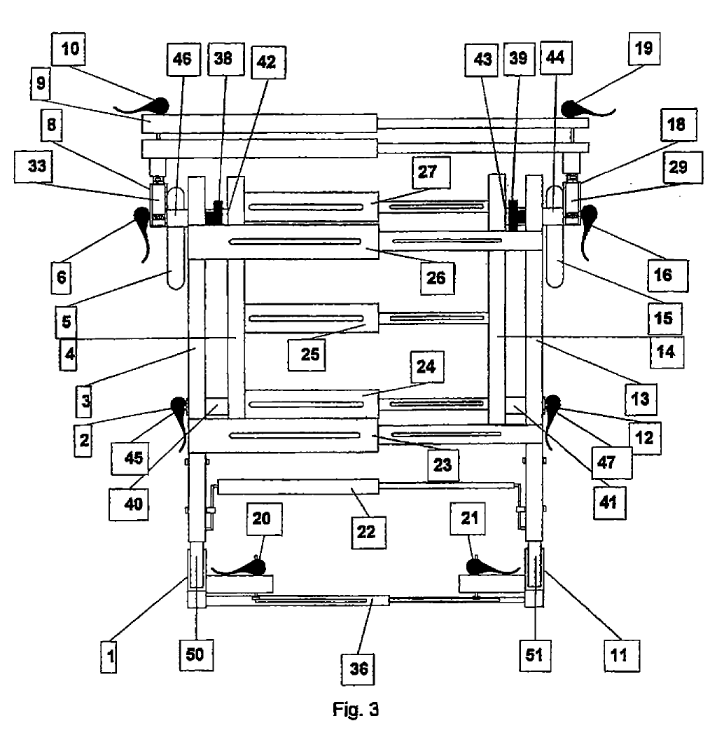

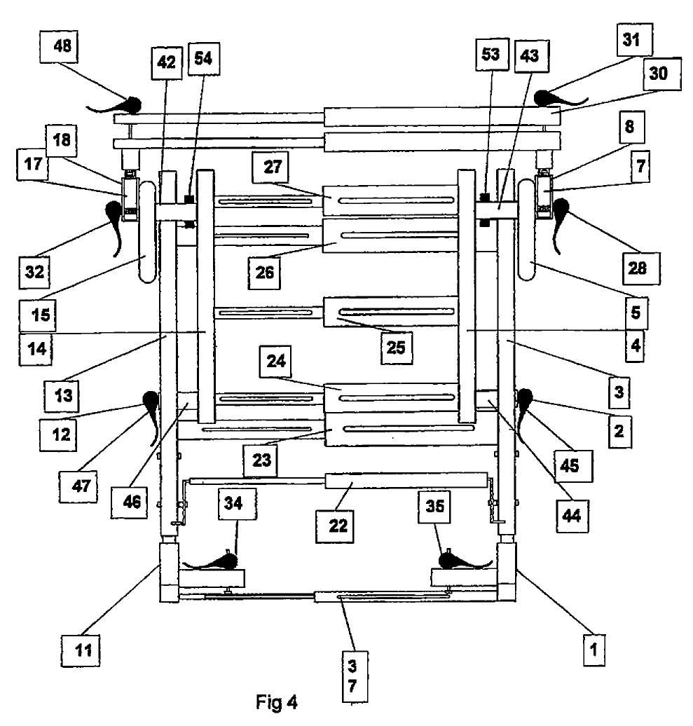

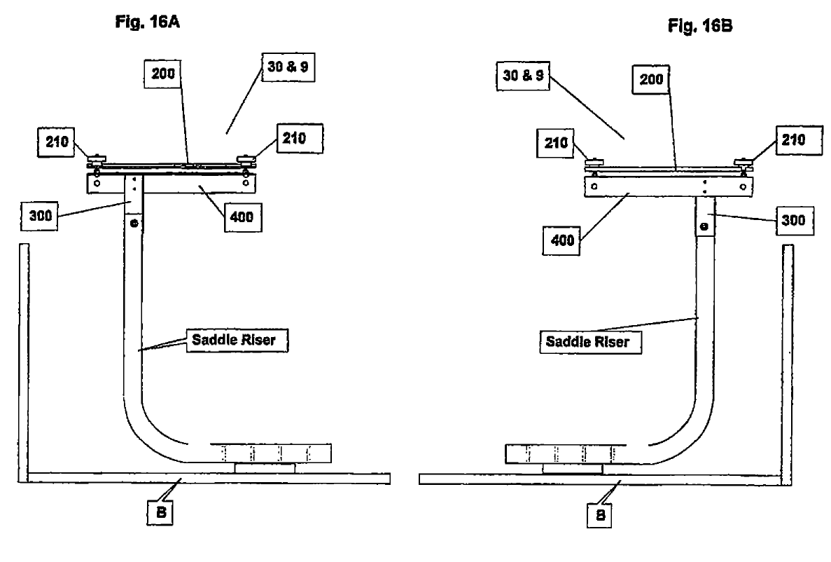

As previously noted, carrier A can have mounted on it a saddle riser such as shown and described in my U.S. Pat. No. 7,051,909. The load clamps 9, 30 (see FIGS. 3 and 4) can, as shown in FIGS. 16A, 16B be installed at the upper end of each saddle riser to clamp a load in place on the carrier, as well as on the top rails of carriers A and A′.

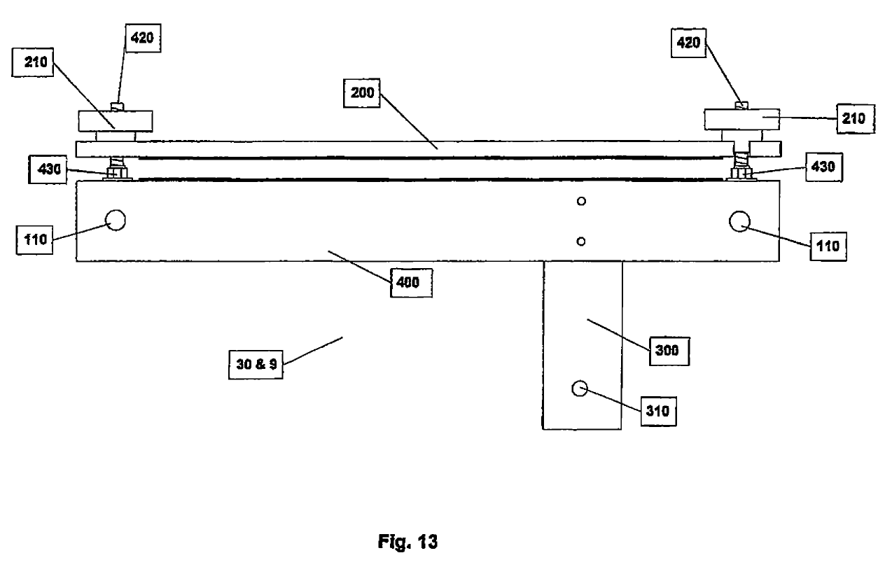

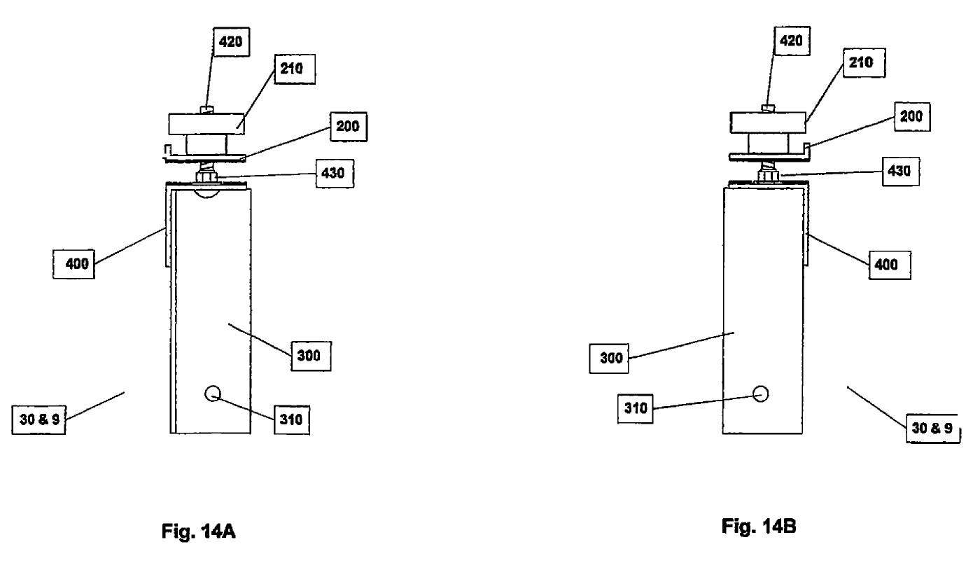

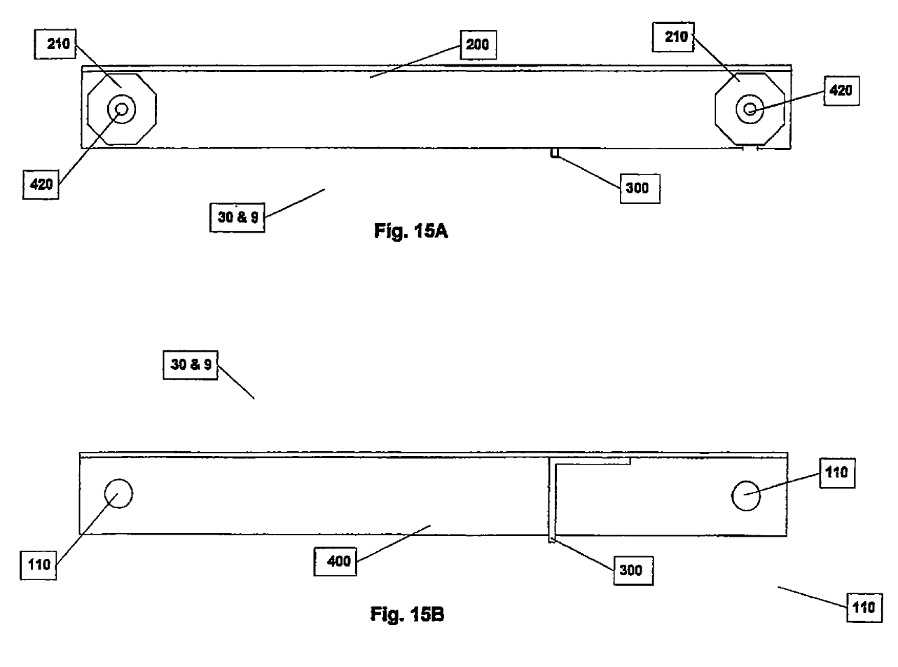

Referring to FIG. 13, a shelf plate 400 is connected to an L-shaped mounting bracket 300 in one segment of which a hole 310 is formed for a bolt such as a carriage bolt 120 to be used to attach the mounting bracket to the vertically extending portion of a saddle riser as shown in FIG. 16B. As shown in FIGS. 14A and 14B, the shelf plate has a top surface which is coated with rubber or another protective coating, and a flange which depends downwardly from the outer edge of the shelf plate.

A clamp plate 200 is installed over the shelf plate. The shelf plate has a bottom surface which is also coated with rubber or another protective coating so that a cargo to be transported by the carrier, when installed between plates 200 and 400 is protected from damage. A flange extends upwardly from the clamp plate at the outer edge of the clamp plate. Clamp plate 200 fits over shelf plate 400 and is spaced from the shelf plate.

Carriage bolts 420 are installed at each end of each shelf plate, using hex nuts and washers 430. The threaded shank of each carriage bolt extends upwardly from the shelf plate through an opening in each end of the clamp plate. A knob 210 installed on the outer, distal end of each carriage bolt is used to raise and lower clamp plate 200 relative to shelf plate 400 so to clamp an object to be transported in place atop the risers.

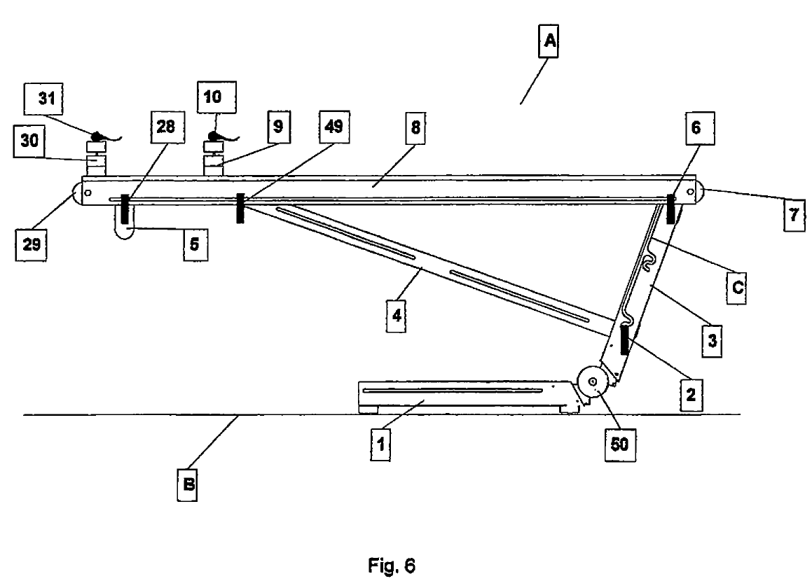

With respect to the carriers A and A′, installation of clamps 9 and 30 is shown, for example, in FIG. 6 and installation and operation of the clamps is as described above.

In view of the above, it will be seen that the several objects and advantages of the present invention have been achieved and other advantageous results have been obtained.

Having thus described the invention, what is claimed and desired to be secured by Letters Patent is:

1. A cargo carrier for installation in the bed of a pickup truck, comprising:
a pair of base rails that rest on a floor of the truck bed;
a pair of first posts each of which has one end hingedly connected to one end of respective base rails for rotating the first posts to raise and lower them;
a pair of second posts each of which has one end slidably received in slots formed in the respective first posts, the slots extending substantially the length of the first posts for the second post to be moved relative the first posts; and,
a pair of top rails each of which has one end connected to the other end of the respective first posts with the other end of each second post being slidably received in a slot in the respective top rails whereby rotational movement of the first posts relative to the base rails, and sliding movement of the second rails to the first rails, raises and lowers the top rails to a desired level above the floor of the truck.

2. The carrier of claim 1 further including load clamp bars affixed to the top rails and movable relative thereto to accommodate cargo of different sizes and clamp the cargo in place on the top of the carrier.

3. The carrier of claim 1 further including a plurality of braces extending between the base rails, the length of the braces being adjustable to adjust the width of the carrier.

4. The carrier of claim 3 further including a plurality of braces extending between the respective posts, the length of the braces being adjustable to adjust the width between the posts.

5. The carrier of claim 1 further includes a plurality cam levers attached to the first posts and the second posts for locking the first posts in a desired position relative to the second posts, and the top rails in a desired position relative to the second posts.

6. The carrier of claim 1 in which the length of the base rails, first posts and second posts is adjustable.

7. The carrier of claim 1 further including a pair of clamps mounted to the top rails for clamping cargo in place on the carrier.

8. The carrier of claim 7 in which each clamp includes a shelf plate connected to the top rail and a clamp plate positioned above the shelf plate and movable relative thereto to clamp an object in place.

9. A cargo carrier for installation in the bed of a pickup truck, comprising:
a pair of base rails that rest on a floor of the truck bed;
a pair of posts each of which has one end hingedly connected to one end of respective base rails for rotating the posts to raise and lower them; and,
a pair of top rails each of which has one end hingedly connected to the other end of the respective posts whereby rotational movement of the posts relative to the base rails, and rotational movement of the top rails to the posts, raises and lowers the top rails to a desired level above the floor of the truck.

10. The carrier of claim 9 further including load clamp bars affixed to the top rails and movable relative thereto to accommodate cargo of different sizes and clamp the cargo in place on the top of the carrier.

11. The carrier of claim 9 further including a plurality of base attachment units for attaching the carrier to the bed of the truck.

12. The carrier of claim 11 further including two pair of base attachment units, each pair being connected to a respective one of the base rails at each end of the base rail.

13. The carrier of claim 12 in which the base attachment units are connected on the inside of the respective base attachment rails.

14. The carrier of claim 11 further including a plurality of cross braces extending between the base attachment rails to add stability to the carrier.

15. The carrier of claim 14 further including three cross braces, one extending between the base rails at each end thereof, and the other between the base rails at the middle of them.

16. The carrier of claim 9 further including a pair of clamps mounted to the top rails for clamping cargo in place on the carrier.

17. The carrier of claim 16 in which each clamp includes a shelf plate connected to the top rail and a clamp plate positioned above the shelf plate and movable relative thereto to clamp an object in place.
